(19) United States
(12) Patent Application Publication
(10) Pub. No.: US 2021/0025082 A1
(43) Pub. Date: Jan. 28, 2021

(54) METHOD OF MANUFACTURING ACRYLONITRILE FIBER BUNDLE AND METHOD OF MANUFACTURING CARBON FIBER BUNDLE

(71) Applicant: Toray Industries, Inc., Tokyo (JP)

(72) Inventors: Yusuke Takechi, Ehime (JP); Isao Nakayama, Ehime (JP); Takeya Ohashi, Ehime (JP)

(21) Appl. No.: 16/981,393

(22) PCT Filed: Mar. 12, 2019
(86) PCT No.: PCT/JP2019/009888

§ 371 Date: Sep. 16, 2020

(30) Foreign Application Priority Data
Mar. 27, 2018 (JP) 2018-059237

(51) Int. Cl. D01F 9/22; D01D 5/06; D01F 6/18; B29C 55/30

(52) U.S. Cl. CPC D01F 9/22; B29C 55/30; D01F 6/18; D01D 5/06

(57) ABSTRACT

A method of manufacturing an acrylonitrile fiber bundle includes drawing a fiber bundle with pressurized steam under a pressurized steam atmosphere using a pressurized steam drawing device, wherein the fiber bundle includes a yarn spun from a spinning solution containing an acrylonitrile copolymer, the pressurized steam drawing device has at least two zones of a preheating zone provided on a fiber bundle introduction side and a heating/drawing zone provided on a fiber bundle extraction side, and a sealing zone has a sealing member and separates the two zones.

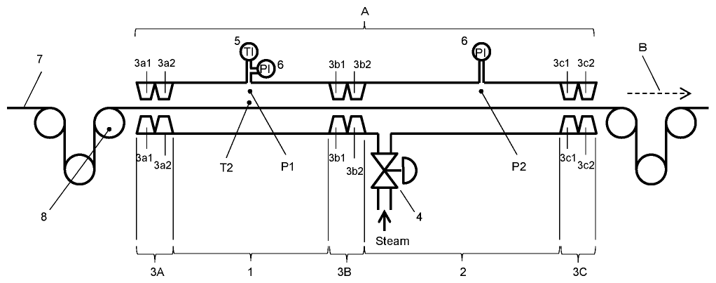

### TECHNICAL FIELD

This disclosure relates to methods of manufacturing acrylonitrile and carbon fiber bundles.

### BACKGROUND

In the manufacture of an acrylonitrile fiber bundle used as a precursor fiber of a carbon fiber bundle, it has been conventionally known to draw the acrylonitrile fiber bundle by pressurized steam. This is because hot water under atmospheric pressure provides a high temperature, and the presence of water causes an effect of plasticizing the acrylonitrile fiber bundle, and enables the acrylonitrile fiber bundle to be drawn at high drawing ratio. However, in drawing the acrylonitrile fiber bundle with pressurized steam at a high drawing ratio, defects such as breakage of monofilaments, generation of fuzz, and breakage of an entire fiber bundle may occur. The same applies when obtaining a low denier fiber bundle or when trying to treat a fiber bundle at higher speed.

Japanese Patent Laid-open Publication No. 2013-159874 discloses a technique in which, by improving a sealing property between a steam box and a steam drawing machine, only steam from the steam drawing machine is supplied to the steam box and, additionally, the flow of the steam can be stabilized in the opposite direction of yarn entry since the steam is supplied from one direction. As a result, damage to the fiber bundle is reduced and the quality improved.

In addition, Japanese Patent Laid-open Publication No. H05-263313 discloses a technique in which, in a drawing method including dividing a drawing step into a preheating zone and a heating/drawing zone, and supplying pressurized steam of different pressures to the zones, to prevent a drawing point from shifting to the preheating zone and being forcedly drawn at a low temperature, wet steam is blown into the heating/drawing zone, wherein the wet steam has higher wetness than wetness of steam blown into the preheating zone.

Japanese Patent Laid-open Publication No. 2008-214795 discloses a technique in which the pressure of pressurized steam used for preheating and the residence time in the preheating, and the pressure of pressurized steam used for drawing and the residence time in the drawing are each controlled within a certain condition range. That technique is suitable for stably manufacturing a high-quality carbon fiber bundle and suppresses the fluctuation rate of the denier.

In addition, Japanese Patent Laid-open Publication No. 2015-30923 discloses a technique in which, to control the temperature of a steam chamber to which pressurized steam is supplied, a seal chamber on an inlet side of a steam drawing device, and outside an inlet of the steam drawing device, while the temperature and the pressure of the steam are being detected, water corresponding to the temperature is supplied to the pressurized steam supplied to the steam chamber with an atomizer, and the temperature difference between the temperature of the steam and the temperature of saturated steam is controlled to 2° C. or less.

However, in the method of Japanese Patent Laid-open Publication No. 2013-159874, when it is attempted to treat the acrylonitrile fiber bundle by drawing at higher speed or at higher drawing ratio, a part of the acrylonitrile fiber bundle is introduced into the steam drawing machine without being subjected to a sufficient plasticizing effect in the steam box and the drawing may occur in an unintended zone. This may lead to variations in quality and breakage of the fiber bundle.

In the method of Japanese Patent Laid-open Publication No. H05-263313, wet steam having high wetness is blown into the heating/drawing zone so that drainage (drips of water) is generated when the wet steam is supplied and collides with a wall surface of the steam drawing device. The drainage attaches to a fiber bundle, and the fiber bundle comes to have a part with the drainage and a part without the drainage. Further, an effect of plasticizing the fiber bundle cannot be efficiently obtained in the part without drainage. This may lead to breakage of a single yarn or breakage of an acrylonitrile fiber bundle.

In the method of Japanese Patent Laid-open Publication No. 2008-214795, it is essential to increase the production speed to enhance production capacity without large capital investment, and the residence time in the preheating zone and the heating zone is shortened so that it is impossible to obtain an amount of heat required for preheating and drawing. This may lead to breakage of a single yarn or breakage of an acrylonitrile fiber bundle.

In the method of Japanese Patent Laid-open Publication No. 2015-30923, as to the steam supplied from the steam chamber to the inlet of the steam drawing device, excess water needs to be supplied to the pressurized steam supplied to the steam chamber to control the temperature difference between the temperature of the seal chamber on the inlet side of the steam drawing device and outside the inlet of the steam drawing device and the temperature of saturated steam to 2° C. or less. If the atomizer reduces the spray diameter of water and steam and water are evenly mixed, water droplets with a large spray diameter are formed in the process of supplying steam. The large water droplets collide with an acrylonitrile fiber bundle to lead to breakage of a single yarn or breakage of the acrylonitrile fiber bundle.

It could therefore be helpful to provide a drawing method having excellent process passability when the acrylonitrile fiber bundle used as the precursor fiber of the carbon fiber bundle is subjected to pressurized steam drawing, particularly when the acrylonitrile fiber bundle is treated by the pressurized steam drawing at high drawing ratio or at high speed, or when a low denier acrylonitrile fiber bundle is to be obtained.

### SUMMARY

We found that the following method enables a more uniform drawing treatment to obtain an acrylonitrile fiber bundle that has excellent process passability. The method is for drawing an acrylonitrile fiber bundle, the method including the step of: drawing a fiber bundle using a pressurized steam drawing device, the pressurized steam drawing device having two zones of a preheating zone provided on a fiber bundle introduction side and a heating/drawing zone provided on an acrylonitrile fiber bundle extraction side, and a sealing zone having a sealing member and separating the two zones. In the method, the pressure difference between the preheating zone and the heating/drawing zone as well as the residence time of the fiber bundle to reside in the sealing zone between the preheating zone and the heating/drawing zone are controlled.

That is, the method of manufacturing an acrylonitrile fiber bundle is a method including the step of: drawing a fiber bundle with pressurized steam under a pressurized steam atmosphere using a pressurized steam drawing device, the fiber bundle including a yarn spun from a spinning solution containing an acrylonitrile copolymer, the pressurized steam drawing device having at least two zones of a preheating zone provided on a fiber bundle introduction side and a heating/drawing zone provided on a fiber bundle extraction side, and a sealing zone having a sealing member and separating the two zones, a pressure P1 (MPa), a pressure P2 (MPa), a difference between P2 and P1, that is, ΔP=P2−P1, and a residence time t (sec) satisfying a relationship 1.0≤ΔP/t≤10, wherein the pressure P1 is a pressure in the preheating zone, the pressure P2 is a pressure in the heating/drawing zone, and the residence time t is a residence time of the fiber bundle in the sealing zone, a minimum load temperature T1 (° C.) of the fiber bundle before being introduced into the pressurized steam drawing device and a temperature T2 (° C.) in the preheating zone satisfying a relationship T1−20≤T2<T1.

The method of manufacturing a carbon fiber bundle is a method including the steps of: manufacturing an acrylonitrile fiber bundle by the above-mentioned method of manufacturing an acrylonitrile fiber bundle, thereafter oxidizing the acrylonitrile fiber bundle in an oxidative atmosphere at 200 to 300° C., and then heating the acrylonitrile fiber bundle in an inert atmosphere at 1000° C. or higher.

The pressurized steam drawing of an acrylonitrile fiber bundle can be performed while suppressing problems such as breakage of the entire fiber bundle. Further, it is possible to prevent breakage of monofilament and generation of fuzz, and stably provide a high-quality acrylonitrile fiber bundle.

### BRIEF DESCRIPTION OF THE DRAWING

The FIGURE is a schematic side view showing an example of a device that performs the pressurized steam drawing treatment.

### DESCRIPTION OF REFERENCE SIGNS

A: Pressurized steam drawing device
B: Traveling direction of fiber bundle
1: Preheating zone
2: Heating/drawing zone
3A: Sealing zone outside preheating zone
3a1: Sealing member
3a2: Sealing member
3B: Sealing zone between preheating zone and heating/drawing zone
3b1: Sealing member
3b2: Sealing member
3C: Sealing zone outside heating/drawing zone
3c1: Sealing member
3c2: Sealing member
4: Steam pressure control device
5: Thermometer (TI)
6: Manometer (PI)
7: Fiber bundle
8: Feed roll

### DETAILED DESCRIPTION

Hereinafter, our methods are described in detail with reference to the FIGURE.

In the method of manufacturing an acrylonitrile fiber bundle, a spinning solution containing an acrylonitrile copolymer is spun to produce a spun yarn, and then a fiber bundle including the spun yarn is subjected to pressurized steam drawing using a pressurized steam drawing device. Before or after pressurized steam drawing using the pressurized steam drawing device, a step known in the field of fiber manufacture can be appropriately performed. For example, in spinning from a solution state of an acrylonitrile fiber bundle, a solution obtained by dissolving the acrylonitrile copolymer containing a homopolymer or a comonomer of acrylonitrile as a raw material polymer in a known organic or inorganic solvent is spun, and then an acrylonitrile fiber bundle of the obtained spun yarn is drawn. During drawing of the acrylonitrile fiber bundle, our pressurized steam drawing can be performed. In this example, the spinning method may be any of the so-called wet spinning, dry-wet spinning, and dry spinning, and desolvating, drawing in a bath, treatment to attach oil, drying and the like can be performed in the subsequent steps. The pressurized steam drawing may be performed at any stage in the fiber manufacture process. However, the pressurized steam drawing is preferably performed after removing the solvent in the fiber bundle to some extent, that is, after washing or after drawing in the bath, or after drying. From the viewpoint of obtaining a highly oriented fiber bundle, the pressurized steam drawing is preferably performed after drying.

Hereinafter, our methods are described by way of examples with reference to the drawing. However, this disclosure should not be interpreted as being limited to the examples. A pressurized steam drawing device A has at least two zones including a preheating zone 1 provided on a fiber bundle introduction side and a heating/drawing zone 2 provided on an acrylonitrile fiber bundle extraction side when performing pressurized steam drawing on the fiber bundle. The preheating zone is a zone in which the fiber bundle is preheated in advance to be drawn more uniformly in the subsequent heating/drawing zone, and the heating/drawing zone is a zone in which the fiber bundle is heated and drawn. The pressurized steam drawing device in which the two zones are separated by a sealing zone 3B having sealing members (3b1 and 3b2) is used, and it is important that a relationship between the pressure difference P2−P1, that is, ΔP and a residence time t (sec) in the sealing zone 3B between the preheating zone and the heating/drawing zone is 1.0≤ΔP/t≤10, wherein the pressure P1 (MPa) is a pressure in the preheating zone, the pressure P2 (MPa) is a pressure in the heating/drawing zone, and the residence time t is a residence time of the fiber bundle in the sealing zone 3B. When the value ΔP/t is within the above-mentioned range, the pressure gradient between the preheating zone 1 and the heating/drawing zone 2 is steep so that the entire fiber bundle is uniformly drawn at once in the heating/drawing zone. As a result, uneven drawing between single yarns is suppressed, and problems such as breakage of the fiber bundle and breakage of a single yarn can be prevented. Furthermore, it is preferable to use a smaller pressurized steam drawing device to increase productivity, and it is preferable that a relationship 2≤ΔP/t≤5 is satisfied to draw the fiber bundle more uniformly.

The pressure P1 in the preheating zone 1 is preferably 0.05 MPa or more and less than 0.35 MPa, and the pressure P2 in the subsequent heating/drawing zone 2 is preferably 0.35 MPa or more and 0.7 MPa or less to perform preheating and heating/drawing effectively. The pressure in the preheating zone and the heating/drawing zone may be measured by a general device, and can be measured, for example, by a Bourdon tube gage. When the pressure P1 in the preheating zone is 0.05 MPa or more and less than 0.35 MPa, uniform preheating can be performed on the entire fiber bundle in the preheating zone, and uniform drawing can be performed in the subsequent heating/drawing zone. Therefore, it may be possible to prevent generation of fuzz in the acrylonitrile fiber bundle. Furthermore, when the pressure P2 in the heating/drawing zone is 0.35 MPa or more and 0.7 MPa or less, a sufficient heat quantity required for drawing the fiber bundle can be obtained and the fiber bundle can be drawn uniformly. Therefore, it may be possible to prevent generation of fuzz in the acrylonitrile fiber bundle.

A plurality of both the preheating zones and the heating/drawing zones can be provided. In that example, the pressure P1 (MPa) in the preheating zone refers to the pressure in the preheating zone that is the closest to the heating/drawing zone, and the pressure P2 (MPa) in the heating/drawing zone refers to the pressure in the heating/drawing zone that is the closest to the preheating zone.

As the sealing member provided in the sealing zone, a so-called labyrinth nozzle that has a plurality of plate pieces extending vertically from an upper surface and a bottom surface of an inner wall of the pressurized steam drawing device in the direction of approaching each other across the running yarns can be used. In addition, a plurality of small-diameter pipes can be used in series. However, it is not particularly limited as long as the pressure difference between the preheating zone and the heating/drawing zone can be created or maintained. The labyrinth nozzle can also be applied to any shape such as a round shape, a rectangular shape, and an elliptical shape, and may be of an integrated type or a split type. Additionally, the labyrinth nozzle is not restricted as to the inner diameter, the number of steps, or the shape of a throttle side. Further, a material having mechanical strength sufficient for sealing to prevent steam leakage is preferably applied to the labyrinth nozzle. For example, as a material for the part that may come into contact with the fiber bundle in a treatment device, particularly, it is preferable to use a material made of stainless steel or chromium-plated steel material since the material has corrosion resistance and suppresses damage to the fiber bundle when the fiber bundle comes into contact with the part, but the material is not limited to these.

As a method of adjusting the pressures in the preheating zone 1 and the heating/drawing zone 2, a method of adjusting the pressure of the steam supplied to the pressurized steam drawing device, or a method of changing the number and shape of the sealing members in a sealing zone 3A outside the preheating zone or a sealing zone 3C outside the heating/drawing zone can be applied. For example, when the pressure loss in the sealing zone is reduced by reducing the number of the sealing members or changing the shape of the sealing members in the sealing zone 3A outside the preheating zone or the sealing zone 3C outside the heating/drawing zone, the pressure in the preheating zone or the heating/drawing zone can be reduced. On the other hand, when the pressure loss in the sealing zone is increased by increasing the number of sealing members or changing the shape of the sealing members in the sealing zone 3A outside the preheating zone or the sealing zone 3C outside the heating/drawing zone, the pressure in the preheating zone or the heating/drawing zone can be increased. Further, the pressure difference between the preheating zone and the heating/drawing zone can be adjusted by changing the number of and the shape of the sealing members in the sealing zone 3B between the preheating zone and the heating/drawing zone. For example, when the pressure loss in the sealing zone is reduced by reducing the number or changing the shape of sealing members in the sealing zone 3B, the pressure difference between the preheating zone and the heating/drawing zone can be reduced. On the other hand, when the pressure loss in the sealing zone is increased by increasing the number or changing the shape of sealing members in the sealing zone 3B, the pressure difference between the preheating zone and the heating/drawing zone can be increased. The residence time t in the sealing zone 3B between the preheating zone and the heating/drawing zone can be changed by the speed at which the fiber bundle is supplied to the pressurized steam drawing device. As a method of adjusting the residence time t, a method of adjusting the length of the sealing zone 3B by increasing or decreasing the number or changing the length of sealing members (3b1 and 3b2) in the sealing zone 3B between the preheating zone and the heating/drawing zone can be applied.

It is important that a minimum load temperature T1 (° C.) of the fiber bundle before being introduced into the pressurized steam drawing device and a temperature T2 (° C.) in the preheating zone satisfy a relationship T1−20≤≤T2<T1.

The minimum load temperature T1 (° C.) is obtained by the following method. The fiber bundle before being introduced into the pressurized steam drawing device is sampled, and one monofilament is taken from the fiber bundle. The monofilament is set on a tensile probe (the sample has a length of 10 mm) TMA4010SA manufactured by Bruker AXS GmbH and, to eliminate the slack of the sample, a tensile load of 0.3 g is applied to the sample, and the load mode is set to be constant length. The load is measured at every 0.5 seconds while increasing the temperature from room temperature to 200° C. in the air at a temperature rising rate of 20° C./min. The temperature at which the load has the minimum value of 50° C. to 200° C. is defined as the minimum load temperature T1. The temperature T2 (° C.) in the preheating zone may be measured with a general device, and can be measured, for example, with a thermocouple.

When a plurality of preheating zones is provided, the temperature T2 (° C.) in the preheating zone refers to the temperature in the preheating zone that is the closest to the heating/drawing zone.

When the relationship T1−20≤T2<T1 is satisfied, it is possible to prevent unintended drawing from partially starting in the preheating zone and, as a result, it is possible to prevent deterioration of the quality due to fuzz. It is preferable to satisfy a relationship T1−15≤T2≤T1−5 to perform sufficient and stable preheating in the preheating zone.

The minimum load temperature T1 of the fiber bundle before being introduced into the pressurized steam drawing device can be changed by changing the content or composition of a copolymerization component contained in the acrylonitrile polymer, or by changing drawing conditions or drying conditions in spinning, but the method of changing the temperature T1 is not particularly limited. The temperature T2 in the preheating zone can be adjusted by the pressure of the pressurized steam supplied to the pressurized steam drawing device, or by the sealing member at both ends of the preheating zone, that is, the number and the shape of the sealing members. Furthermore, the temperature T2 in the preheating zone can be adjusted by cooling the preheating zone with water or the like or by heating the preheating zone with an electric heater or the like from outside of the device.

Further, the method of manufacturing an acrylonitrile fiber bundle can be particularly preferably used when a single yarn of the fiber bundle before being introduced into the pressurized steam drawing device has a roundness of 0.9 or more. The roundness of the single yarn is obtained by the following method. The fiber bundle before being introduced into the pressurized steam drawing device is sampled, and cut perpendicular to the fiber axis with a razor, and the cross-sectional shape of a monofilament is observed using an optical microscope. The measurement magnification shall be such that the thinnest monofilament is displayed as about 1 mm, and the number of pixels of equipment used shall be 2 million pixels. By analyzing the obtained image, the cross-sectional area and the perimeter of the single yarns that form the fiber bundle are obtained, and the diameter (fiber diameter) of the cross section of the single yarn assuming that the cross section is a perfect circle is calculated and obtained in a unit of 0.1 from the cross-sectional area. Then, the roundness of the single yarn forming the fiber bundle can be obtained by using the formula of roundness=4πS/L² (wherein S represents the cross-sectional area of the single yarn, and L represents the perimeter of the single yarn). When the roundness of the single yarn is 0.9 or more, the fiber bundle is formed in a dense state, and it becomes possible to perform a more uniform drawing treatment in the pressurized steam drawing device so that the desired effect is easy to appear. The roundness of the single yarn of the fiber bundle can be adjusted by changing spinning coagulation conditions and drawing conditions.

Next, a method of manufacturing a carbon fiber bundle from the acrylonitrile fiber bundle obtained by the method of manufacturing an acrylonitrile fiber bundle is described.

The acrylonitrile fiber bundle manufactured by the above-mentioned method of manufacturing an acrylonitrile fiber bundle is oxidized in an oxidative atmosphere such as the air at 200 to 300° C. It is preferable that the temperature of the oxidizing treatment is raised in multiple stages from low temperature to high temperature to obtain an oxidized fiber bundle, and it is preferable to draw the fiber bundle at a high draw ratio within a range in which fuzz is not generated, to sufficiently express the performance of the carbon fiber bundle. Then, the obtained oxidized fiber bundle is heated to 1000° C. or higher in an inert atmosphere such as nitrogen to manufacture the carbon fiber bundle. Then, a functional group can be added to the surface of the carbon fiber bundle to enhance adhesiveness with a resin by performing anodization in an electrolyte aqueous solution. Further, it is preferable to add a sizing agent such as an epoxy resin to obtain a carbon fiber bundle having excellent scratch resistance.

### EXAMPLES

Hereinafter, our methods are described more specifically with reference to examples. ΔP Measurement

The pressure at the central portion in the traveling direction of the fiber bundle in each of the preheating zone and the heating/drawing zone was measured with a Bourdon tube gage.

ΔP (MPa) was calculated from the measured pressure P1 (MPa) in the preheating zone and the pressure P2 (MPa) in the heating/drawing zone by the following formula.

ΔP=P2−P1

Residence time t (sec) in sealing zone between preheating zone and heating/drawing zone of pressurized steam drawing device

The speed of a feed roll that supplies the fiber bundle to the pressurized steam drawing device was measured with a surface speedometer, and the residence time t was calculated by the following formula.

(Length (m) of sealing member between preheating zone and heating/drawing zone)/(speed of feed roll (m/sec))=(residence time t (sec) in sealing zone between preheating zone and heating/drawing zone).

### T2: Temperature in Preheating Zone

In the preheating zone, at a central portion in the traveling direction of the fiber bundle, a vertical position and a position 1 mm away from the traveling fiber bundle were measured with a thermocouple to obtain the temperature T2 in the preheating zone. The measurement was carried out by using a drawing device equipped with a sight glass while confirming that the thermocouple and the traveling fiber bundle were not in contact with each other.

### T1: Minimum Load Temperature

The fiber bundle before being introduced into the pressurized steam drawing device was sampled, and one monofilament was taken from the fiber bundle. The monofilament was set on a tensile probe (the sample had a length of 10 mm) TMA4010SA manufactured by Bruker AXS GmbH and, to eliminate the slack of the sample, a tensile load of 0.3 g was applied to the sample, and the load mode was set to be constant length. The load was measured at every 0.5 seconds while increasing the temperature from room temperature to 200° C. in the air at a temperature rising rate of 20° C./min. The temperature at which the load had the minimum value of 50° C. to 200° C. was read. The measurement was repeated 10 times, and the average value was defined as T1.

### Number of Labyrinths

The number of the sealing members (labyrinth nozzles) in the sealing zone between the preheating zone and the heating/drawing zone of the pressurized steam drawing device was counted.

### Roundness

The fiber bundle before being introduced into the pressurized steam drawing device was sampled at a position 10 cm away from the pressurized steam drawing device, and cut perpendicular to the fiber axis with a razor, and the cross-sectional shape of a monofilament was observed using an optical microscope. The measurement magnification was such that the thinnest monofilament was displayed as about 1 mm, and the number of pixels of equipment used was 2 million pixels. By analyzing the obtained image, the cross-sectional area and the perimeter of the single yarns that form the fiber bundle were obtained, and the diameter (fiber diameter) of the cross section of the single yarn assuming that the cross section was a perfect circle was calculated and obtained in a unit of 0.1 μm from the cross-sectional area. Then, the roundness of the single yarn forming the fiber bundle was obtained by using the following formula. The roundness was defined as the average value of 10 randomly selected single yarns

Roundness=4nπ/L²

wherein S represents the cross-sectional area of the single yarn, and L represents the perimeter of the single yarn.

### Quality of Acrylonitrile Fiber Bundle

After performing pressurized steam drawing with a pressurized steam drawing device, the number of fuzz balls having a size of 0.3 mm or more of the acrylonitrile fiber bundle per 1000 m before winding the acrylonitrile fiber bundle was counted, and the quality was evaluated. The evaluation criteria are as follows.

1: 0≤number of fuzz≤1
2: 1<number of fuzz≤2
3: 2<number of fuzz≤5
4: 5<number of fuzz<60
5: number of fuzz≥60

### Process Passability of Acrylonitrile Fiber Bundle

The process passability was evaluated from the number of yarn breakages per a production volume of 10 t of the acrylonitrile fiber bundle. The evaluation criteria are as follows.

1: 0≤number of yarn breakages≤1
2: 1<number of yarn breakages≤2
3: 2<number of yarn breakages≤3
4: 3<number of yarn breakages<5
5: number of yarn breakages≥5

### Example 1

A dimethyl sulfoxide solution of an acrylonitrile copolymer containing 99 mol % acrylonitrile and 1 mol % itaconic acid was dry-wet spun using a 4000-hole spinneret, and immediately three yarns were combined to form 12000 filaments. The filaments were drawn at a drawing ratio of 2 in warm water of 40° C. and washed with water, further drawn at a drawing ratio of 2 in warm water of 70° C., and then dried to obtain a fiber bundle including 12000 filaments and having a total denier of 66000 dtex. The fiber bundle was introduced into the pressurized steam drawing device A (provided with 30 labyrinth nozzles in the sealing zone 3B) shown in the FIGURE and drawn under the conditions shown in Table 1 to obtain an acrylonitrile fiber bundle including 12000 filaments and having a monofilament denier of 1.1 dtex. The roundness of the monofilament was evaluated by sampling the fiber bundle before being introduced into the pressurized steam drawing device. Table 1 shows the results of evaluating the quality and process passability for the obtained acrylonitrile fiber bundle, and the results of measuring the temperature in the pressurized steam drawing device.

### Examples 2, 4, and 5

An acrylonitrile fiber bundle was obtained in the same manner as in Example 1 except that ΔP/t was changed by changing the number of sealing members in the sealing zone between the preheating zone and the heating/drawing zone of the pressurized steam drawing device to change the residence time t in the sealing zone, and by changing the shape of the sealing members to change the pressure difference ΔP as shown in Table 1. Table 1 shows the results of evaluating the quality and process passability for the obtained acrylonitrile fiber bundle, and the results of measuring the temperature in the pressurized steam drawing device.

### Example 3

An acrylonitrile fiber bundle was obtained in the same manner as in Example 1 except that spinning coagulation conditions were changed to change the roundness of the acrylonitrile fiber bundle before being introduced into the pressurized steam drawing device as shown in Table 1. Table 1 shows the results of evaluating the quality and process passability for the obtained acrylonitrile fiber bundle, and the results of measuring the temperature in the pressurized steam drawing device.

### Example 6

An acrylonitrile fiber bundle was obtained in the same manner as in Example 1 except that a dimethyl sulfoxide solution of an acrylonitrile copolymer containing 98.5 mol % acrylonitrile, 1 mol % itaconic acid, and 0.5 mol % methyl acrylate was used for spinning to change the minimum load temperature. Table 1 shows the results of evaluating the quality and process passability for the obtained acrylonitrile fiber bundle, and the results of measuring the temperature in the pressurized steam drawing device.

### Example 7

An acrylonitrile fiber bundle was obtained in the same manner as in Example 1 except that the number and the shape of sealing members in the sealing zone between the preheating zone and the heating/drawing zone of the pressurized steam drawing device were changed and the shape of the sealing member in the sealing zone 3A outside the preheating zone was changed to change the temperature in the preheating zone as shown in Table 1. Table 1 shows the results of evaluating the quality and process passability for the obtained acrylonitrile fiber bundle, and the results of measuring the temperature in the pressurized steam drawing device.

### Comparative Examples 1 and 2

An acrylonitrile fiber bundle was obtained in the same manner as in Example 1 except that the number and the shape of sealing members in the sealing zone between the preheating zone and the heating/drawing zone of the pressurized steam drawing device were changed to change ΔP/t as shown in Table 1. Table 1 shows the results of evaluating the quality and process passability for the obtained acrylonitrile fiber bundle, and the results of measuring the temperature in the pressurized steam drawing device.

### Comparative Example 3

An acrylonitrile fiber bundle was obtained in the same manner as in Example 1 except that a dimethyl sulfoxide solution of an acrylonitrile copolymer containing 98 mol % acrylonitrile, 1 mol % itaconic acid, and 1 mol % methyl acrylate was used for spinning to change the minimum load temperature. Table 1 shows the results of evaluating the quality and process passability for the obtained acrylonitrile fiber bundle, and the results of measuring the temperature in the pressurized steam drawing device.

### Comparative Example 4

An acrylonitrile fiber bundle was obtained in the same manner as in Example 1 except that the shape of the sealing member in the sealing zone 3A outside the preheating zone was changed to change the temperature in the preheating zone as shown in Table 1. Table 1 shows the results of evaluating the quality and process passability for the obtained acrylonitrile fiber bundle, and the results of measuring the temperature in the pressurized steam drawing device.

TABLE 1

| | | | | | | | | | Compar- | Compar- | Compar- | Compar- |
|---|---|---|---|---|---|---|---|---|---|---|---|---|
| | | Exam- | Exam- | Exam- | Exam- | Exam- | Exam- | Exam- | ative | ative | ative | ative |
| | | ple 1 | ple 2 | ple 3 | ple 4 | ple 5 | ple 6 | ple 7 | Example 1 | Example 2 | Example 3 | Example 4 |
| ΔP/t | MPa/sec | 2.0 | 4.0 | 2.0 | 1.3 | 8.6 | 2.0 | 2.0 | 14.3 | 0.7 | 2.0 | 2.0 |
| Load minimum | ° C. | 140 | 140 | 140 | 140 | 140 | 135 | 140 | 140 | 140 | 130 | 140 |
| temperature (T1) | | | | | | | | | | | | |
| Temperature in | ° C. | 134 | 134 | 134 | 134 | 134 | 134 | 122 | 134 | 134 | 134 | 118 |
| preheating region (T2) | | | | | | | | | | | | |
| Number of labyrinths | pieces | 30 | 15 | 30 | 45 | 7 | 30 | 37 | 4 | 90 | 30 | 30 |
| Roundness | — | 0.93 | 0.93 | 0.75 | 0.93 | 0.93 | 0.93 | 0.93 | 0.93 | 0.93 | 0.93 | 0.93 |
| Quality of acrylonitrile | — | 2 | 2 | 2 | 2 | 2 | 2 | 2 | 5 | 5 | 4 | 4 |
| fiber bundle when | | | | | | | | | | | | |
| manufactured | | | | | | | | | | | | |
| Number of yarn break- | — | 1 | 1 | 2 | 2 | 2 | 2 | 2 | 4 | 5 | 4 | 5 |
| ages during manufac- | | | | | | | | | | | | |
| ture of acrylonitrile | | | | | | | | | | | | |
| fiber bundle | | | | | | | | | | | | |

1.-3. (canceled)

4. A method of manufacturing an acrylonitrile fiber bundle, the method comprising:
drawing a fiber bundle with pressurized steam under a pressurized steam atmosphere using a pressurized steam drawing device,
wherein the fiber bundle includes a yarn spun from a spinning solution containing an acrylonitrile copolymer,
the pressurized steam drawing device has at least two zones of a preheating zone provided on a fiber bundle introduction side and a heating/drawing zone provided on a fiber bundle extraction side, and a sealing zone has a sealing member and separates the two zones,
a pressure P1 (MPa), a pressure P2 (MPa), a difference between P2 and P1, ΔP=P2−P1, and a residence time t (sec) satisfying 1.0≤ΔP/t≤10,
the pressure P1 is a pressure in the preheating zone, the pressure P2 is a pressure in the heating/drawing zone, and the residence time t is a residence time of the fiber bundle in the sealing zone,
a minimum load temperature T1 (° C.) of the fiber bundle before being introduced into the pressurized steam drawing device and a temperature T2 (° C.) in the preheating zone satisfying T1−20≤T2<T1.

5. The method according to claim 4, wherein a single yarn of the fiber bundle before being introduced into the pressurized steam drawing device has a roundness of 0.9 or more.

6. A method of manufacturing a carbon fiber bundle, the method comprising: manufacturing an acrylonitrile fiber bundle by the method according to claim 4, oxidizing the acrylonitrile fiber bundle in an oxidative atmosphere at 200 to 300° C., and heating the acrylonitrile fiber bundle in an inert atmosphere at 1000° C. or higher.

7. A method of manufacturing a carbon fiber bundle, the method comprising: manufacturing an acrylonitrile fiber bundle by the method according to claim 5, oxidizing the acrylonitrile fiber bundle in an oxidative atmosphere at 200 to 300° C., and heating the acrylonitrile fiber bundle in an inert atmosphere at 1000° C. or higher.
